(19) United States
(12) Patent Application Publication
(10) Pub. No.: US 2023/0169426 A1
(43) Pub. Date: Jun. 1, 2023

(54) DEMAND RESPONSE RESOURCE SCHEDULING

(71) Applicant: NCR Corporation, Atlanta, GA (US)

(72) Inventors: Kip Oliver Morgan, Atlanta, GA (US); Jerry Steven Massey, Lawrenceville, GA (US); Zachary Taylor Lasater, Atlanta, GA (US)

(21) Appl. No.: 17/537,581

(22) Filed: Nov. 30, 2021

(51) Int. Cl. G06Q 10/06; G06Q 30/02

(52) U.S. Cl. CPC G06Q 10/06312; G06Q 10/06315; G06Q 30/0202

(57) ABSTRACT

Historical transaction loads for transactions of a store are determined. Constraints are obtained for staff of the store over a given period of time in the future. The historical loads are forecasted into projected transaction loads for the given period of time. The constraints are processed to generate a dispatch demand schedule for the staff over the given period of time. The dispatch demand schedule is translated into a staff/worker schedule and provided to a scheduling system of the store.

### BACKGROUND

Retailers are continuously struggling with optimal staffing based on their existing and projected customer traffic. Nothing frustrates customers more than long lines waiting to checkout of a store. Some customers who experience these situations more than once with a given store may not return to shop at that store. Furthermore, the longer a customer is waiting in a line to checkout, the less revenue and sales that are being recorded by the store. Customers may exit a store with the intent of coming at a later time when they see long checkout lines, but some of those customers may go to a different store instead and some may never return.

However, overstaffed retailers during light customer traffic also presents issues for the retailers, which are costly. Salaries of staff present in the store have to be paid and store managers struggle with finding meaningful tasks to keep their employees busy during their shifts; often the tasks are non-critical or redundant. The employees may be sent home early from a shift when they planned or were counting on being paid for a full shift of work. Employees may begin looking for other employment because they fear the store's business is in decline and they want to find work before the employer lets them go; they rely on steady shift pay, and/or they want to feel needed, and they want more than trivial tasks to do during their shifts.

Store managers develop staffing schedules based largely on their own experience with the resource needs of the stores. New store managers struggle with inexperience and therefore often miss on scheduling optimal staff for shifts, which impacts the profitability of the stores.

Some managers may user their own subjectively obtained store metrics to estimate staffing needs in a resource schedule. If this works for them a few times, they stay with it even when they have days when the schedule is over or under staffed. In short, these approaches are ad hoc and are only marginally based on hard data.

It is difficult to predict retail staffing schedules because of so many variables that impact the availability of staff and the actual staffing needs. Employees have vacation schedules and there are seasonal staffing levels that increase or decrease the available staff based on a current season.

### SUMMARY

In various embodiments, a system and methods for demand response resource scheduling are presented.

According to an embodiment, a method for demand response resource scheduling is provided. A transaction load is calculated from historical transaction data for a given store and constraints for staff of the store are obtained. A demand transaction load is forecasted from the transaction load and the historical transaction data over a given period of time projected into the future. A dispatch demand schedule is generated for the staff of the store based on the demand transaction load and the constraints for the given period of time.

### BRIEF DESCRIPTION OF THE DRAWINGS

FIG. 1 is a diagram of a system for demand response resource scheduling, according to an example embodiment.

FIG. 2 is a diagram of a method for demand response resource scheduling, according to an example embodiment.

FIG. 3 is a diagram of another method for demand response resource scheduling, according to an example embodiment.

### DETAILED DESCRIPTION

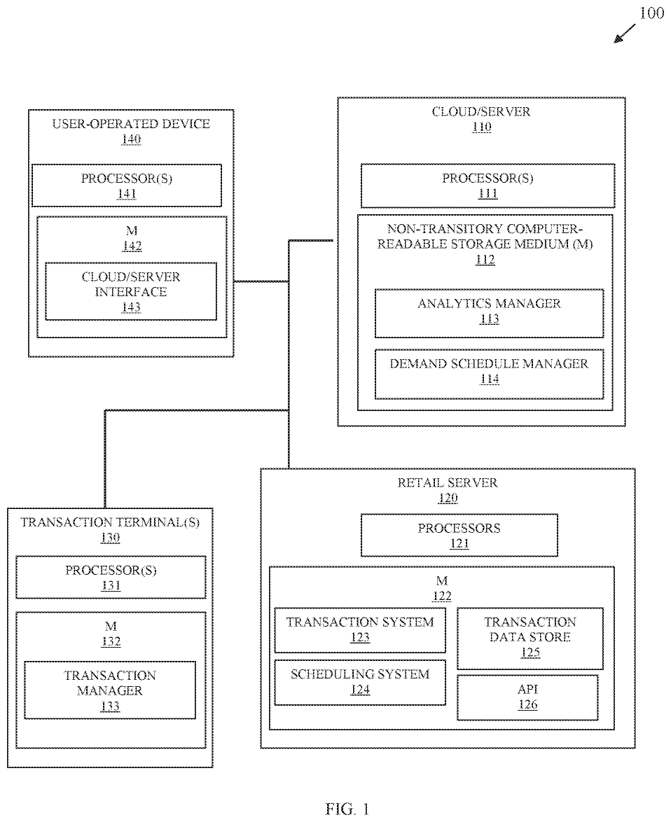

FIG. 1 is a diagram of a system/platform 100 for demand response resource scheduling, according to an example embodiment, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of demand response resource scheduling, presented herein and below.

Demand response systems for power utilities are mature software applications. These systems forecast a power load for a community and create daily dispatch schedules for machine operators. These systems employ statistics, analytics, and machine learning models. Load history, time of day, day of week, holidays, and weather data are the main inputs provided to these systems. Major events such as conventions and planned events can also be accounted for in the input to these systems.

System 100 leverages, enhances, and modifies these systems for purposes of producing detailed resource schedules for a retail store. The level of detail for the scheduling by system 100 can be intraday, day, week, month, and/or even quarter of a year. Multiple levels of detail can be provided and provided in an output format that can be delivered and processed by a store's schedule/calendaring system or multiple stores' schedule/calendaring systems.

The terms “customer” or “consumer” refers to an individual shopping at a store that performs checkouts with the store with items being purchased. An “employee,” a “cashier,” an “assistant,” “staff,” “staff member,” “attendant,” and/or a “clerk” may be used interchangeably and synonymously; these terms refer to an individual that works at a store either overseeing a bank of Self-Service Terminals (SSTs) or operating a Point-Of-Sale (POS) terminal during customer checkouts at the store.

A “load” refers to a rate of transactions being conducted at a store during a given hour (average or total transaction per hour). The POS terminals and the SSTs can have a same or different load. The type of load refers to the load at a transaction terminal type. For example, a transaction terminal type is a bank of SSTs for self-checkouts may have a load of X transactions per hour and POS terminals for cashier assisted transactions may have a load of Y transactions per hour.

A “schedule” refers to a calendar data structure for employees of a given store that are to work shifts of predefined durations over a given projected period of time (day, week, month, quarter of year). Each employee has a shift duration per calendar day and a shift type associated with scalar-mapped skillset value of the given employee. For example, Kip's skillset includes his ability to be a cashier on a POS terminal for cashier-assisted checkouts and his ability to be an assistant that oversees a bank of SSTs. In another example, Jerry's skillset includes the ability or just the desire to only be a cashier. Skillsets of employees are represented as scalar values that corresponding to the transaction terminal load types. The calendar data structure comprises calendar dates over a projected or forecasted period of time with time-of-day entries for each hour of a given calendar day along with an employee identifier/name, a start time-of-day for the employee's shift (which corresponds to a transaction load), an end time-of-day for the employee's shift, and the employee's skillset (corresponding to the transaction terminal load type).

A “dispatch schedule” is a schedule that is produced by system 100 for a given level of detail or granularity over a forecasted period of time (day, week, month, quarter) based on a projected/forecasted demand load. Multiple dispatch schedules are schedules of different levels of detail produced as output from system 100, such as a monthly schedule, a weekly schedule, an hourly schedule within a given day of the month.

A variety of embodiments and operational features of system 100 are now discussed with reference to FIG. 1.

Cloud/server 110 comprises at least one processor 111 and a non-transitory computer-readable storage medium 112. Medium 112 comprises executable instructions for an analytics manager 113 and demand schedule manager 114. The executable instructions when provided to processor 111 from medium 112 cause the processor 111 to perform operations discussed herein and below with respect to 113-114.

Retail server 120 comprises at least one processor 121 and a non-transitory computer-readable storage medium 122. Medium 122 comprises executable instructions for a transaction system 123, a scheduling system 124 and an API 126. The executable instructions when provided to processor 121 from medium 122 cause processor 121 to perform operations discussed herein and below with respect to 123, 124, and 126. Medium 132 also comprises a transaction data store 125 comprising transaction data and transaction metrics for a given store.

Each transaction terminal 130 comprises at least one processor 131 and a non-transitory computer-readable storage medium 132. Medium 132 comprises executable instructions for a transaction manager 133. The executable instructions when provided to processor 131 from medium 132 cause processor 131 to perform operations discussed herein and below with respect to 133.

User-operated device 140 comprises at least one processor 141 and a non-transitory computer-readable storage medium 142. Medium 142 comprises executable instructions for a cloud/server interface 143. The executable instructions when provided to processor 141 from medium 142 cause processor 141 to perform operations discussed herein and below with respect to 143.

Dispatch schedules are mapped to employees and their shifts by demand schedule manager 114 according to their skillsets (load types—ability to work transaction terminal types of SSTs attendants and/or POS terminal cashiers).

Transaction manager 133 processes transactions from terminals 130 and produces transaction data captured in transaction data store 125. A terminal may include an SST or a POS terminal.

Initially historical load demands are generated by analytics manager 113 using API 126 to access transaction data store 125. Analytics manager 113 obtains the historical transactions from data store 125 and creates a data structure that generates an average number of transactions per hour and plots the average number of transactions of a given historical period of time, such as a year, a particular month for multiple years, etc. Each plotted point corresponds to a particular load (average number of transactions per hour) on a given time of day and a given calendar date. Additional information is maintained with each plotted point, such as day of week, holiday and if so which holiday, sale was active and if so what item and what was the offer, historical weather experienced (obtainable from a weather service), events (sports, etc.), day of week, store's season (back-to-school, winter, spring, summer, fall, etc.), etc. So, the historical load represents a plot of the average load by hour over a historical period of time along with multiple dimensions of additional data available for any given plotted point via the data structure.

Demand schedule manager 114 receives as input the historical load demand plotted over the historical time period along with the data structure for additional multidimensional data available for each plotted load at a given historical time of day and historical calendar date. Demand schedule manager 114 also obtains weather forecasts available through a web-based weather service for predicted weather over the next week and/or month at a physical location associated with the store. Extended weather forecasts that extend beyond a month may also be obtained from weather projection services.

Schedule manager 114 also obtains a variety of constraints obtained from scheduling system 124 and/or a user provided through cloud/server interface 143. These constraints include holiday schedules for the store, planned sales, planned events, employee vacation schedules, each employees minimum and maximum hours needed per week/month, each employees maximum daily shift (such as 8 hours, 4 hours, etc.), and each employees scalar mapped skillset (load type can the worker do one or both of operate a POS terminal and/or oversee a bank of SSTs as an SST attendant/assistant.

The input collected by schedule manager 114 comprises the historical load, the data structure with multidimensional data, and the constraints. Schedule manager 114 maps the average transactions per hour from the historical load demand to a kWh recognized as a load of a power demand response system, maps an employee identifier to a power generating machine recognized by the power demand response system based on the skillset (load type) of each employee. For example 1 skill set (capable of just operating a POS terminal or just overseeing a bank of SSTs) corresponds to a single-phase power generating load type machine recognized by the power demand response system; 2 skillsets (capable of performing both duties of the POS terminal and the SST overseer) corresponds to three phased power generating load type machine recognized by the power demand response system. Schedule manager 114 also maps the constraints to characteristics of a given load type of power generating machine (single phase or three phase).

The mapped input is provided as input to the power demand response system by schedule manager 114 and the output is a power dispatch schedule for the machines with varying levels of detail (per hour, per day, per week, per month, per quarter) based on a maximum forecasted power demand over a forecasted period of time.

Output in the power demand schedule comprises a start time and a duration for each power generating machine and considers costs associated with running the power generating machine. This corresponds to a start and end time (start time plus duration) of a given worker (mapped to a power generating machine) that considers or factors in the constraints. For example, Joe takes 30 minutes to get to work, and only has the skills to be a cashier, and he needs at least a 2-hour shift. Joe is mapped to a single-phase power generating machine that takes 30 minutes to start and must run for at least 2 hours. In another example, Susy can work either as an SST assistant or as a POS terminal cashier. Susy is mapped to a three-phase power generating machine (such as a given turbine that can produce single phase or three phase power).

Schedule manager 114 translates the power dispatch schedule into a dispatch schedule for the workers to operate the transaction terminals 130 (SSTs overseers and POS terminal cashiers).

The dispatch schedule is translated into a data format that is recognized by scheduling system 124 and provided as a worker schedule for the store. The worker schedule is viewable by a user through cloud/server interface 143 or through an interface provided by a given retailer for scheduling system 124.

In an embodiment, schedule manager 114 utilizes a modified power demand response system that comprises time series analysis, machine-learning, multiple linear regression, and other algorithms to process the historical load, the multiple dimensional data, and the constraints as input and produce as output a forecasted transaction load and the corresponding dispatch schedule (worker schedule).

The load recognized by a power demand response system is power by kWh, schedule manager 114 maps load recognized by the power demand response system to scalar values for transactions per hour, such that 1 kWh of power is equivalent to 1 transaction per hour. The single-phase power machine recognized by a power demand system, is mapped to an employee having a scalar skillet of just being able to perform duties at a POS terminal or at a bank of SSTs. The three-phase power machine recognized by a power demand system, is mapped to an employee having a scaler skillset of being able to perform duties at both a POS terminal and a bank of SSTs. Power demand systems are configured to already predict and meet a maximum forecasted power load with minimal power excess; similarly, schedule manager 114 produces a worker scheduler of workers to meet a maximum forecasted transaction load with minimal excess.

In an embodiment, schedule manager 114 generates a worker schedule (demand schedule) daily with any revised constraints or revised worker availability.

In an embodiment, schedule manager 114 can be provided revised constraints and revised on demand with worker availability via cloud/server interface 143 through cloud/server interface 143.

In an embodiment, the worker schedule at an intraday level of detail (by hour) may show that during select hours for a given day (for example 2-4 pm) the forecasted transaction load is low, such that workers will not be fully busy during these hours, but they cannot be sent home since the load in subsequent hours is projected to be high (for example, 4-6 pm). A manager/user may propose a sale during the hours of 2-4 pm and feed the revised constraints for a sale during the non-busy hours through cloud/server interface 143 for purposes of seeing how that will affect the transaction load during those hours. In this way, system 100 may be used to increase customer traffic and sales while maximizing the productivity of workers on site for a given day. In this way, system 100 may also be used for real-time transaction load shaping to optimize the efficiencies of staff on site and optimize customer sales/traffic.

System 100 provides precise staff scheduling capabilities that leverages robust power demand response systems for purposes of maximizing retail sales, maximizing staff efficiencies, and optimizing retail sales while increasing customer satisfaction by having adequate staff to handle customer traffic for checkouts at any given point in time.

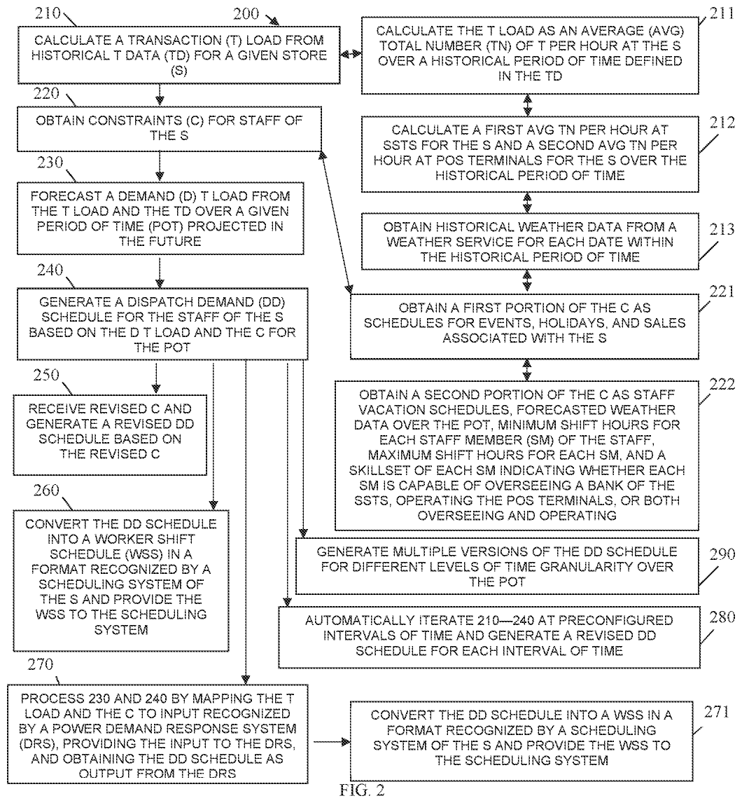

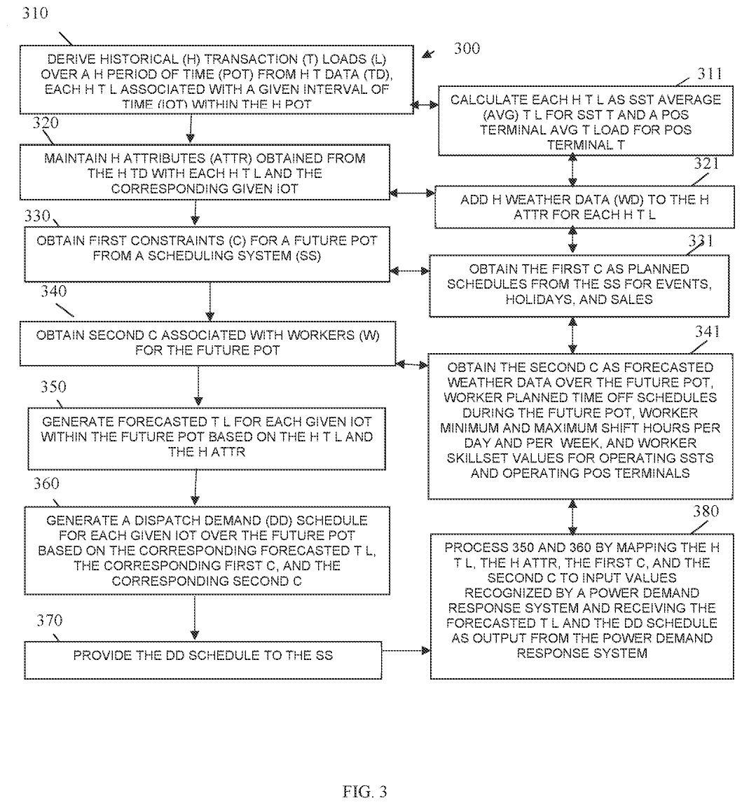

The above-referenced embodiments and other embodiments are now discussed within FIGS. 2-3.

FIG. 2 is a diagram of a method 200 for demand response resource scheduling, according to an example embodiment. The software module(s) that implements the method 200 is referred to as a “demand response scheduler.” The demand response scheduler is implemented as executable instructions programmed and residing within memory and/or a non-transitory computer-readable (processor-readable) storage medium and executed by one or more processors of one or more devices. The processor(s) of the device that executes the demand response scheduler are specifically configured and programmed to process the demand response scheduler. The demand response scheduler may have access to one or more network connections during its processing. The network connections can be wired, wireless, or a combination of wired and wireless.

In an embodiment, the device that executes the demand response scheduler is cloud 110. In an embodiment, the device that execute the demand response scheduler is server 110.

In an embodiment, the demand response scheduler is all or some combination of 113 and 114.

At 210, the demand response scheduler calculates a transaction load historical transaction data for a given store.

In an embodiment, at 211, the demand response scheduler calculates the transaction load as an average total number of transaction per hour at the store over a historical period of time defined in the transaction data. Each interval of time within the historical period of time (such as 1 hour) comprises its own calculated transaction load.

In an embodiment of 211 and at 212, the demand response scheduler calculates a first average transaction number per hour at SSTs for the store and a second average transaction number per hour at POS terminals for the store over the historical period of time and for each hour over the period of time.

In an embodiment of 212 and at 213, the demand response scheduler obtains historical weather data from a weather service for each date within the historical period of time.

At 220, the demand response scheduler obtains constraints for staff (workers) of the store.

In an embodiment of 213 and 220, at 221, the demand response scheduler obtains a first portion of the constraints as schedules for events, holidays, and sales associated with the store.

In an embodiment of 221 and at 222, the demand response scheduler obtains a second portion of the constraints as staff vacation schedules, forecasted weather data over the period of time, minimum shift hours for each staff member, maximum shift hours for each staff member, and a skillset of each staff member indicating whether each staff member is capable of overseeing a bank of the SSTs, operating the POS terminals or both overseeing the bank of SSTs and operating the POS terminals.

At 230, the demand response scheduler forecasts a demand transaction load from the transaction load and the transaction data over a given period of time projected in the future.

At 240, the demand response scheduler generates a dispatch demand schedule for the staff of the store based on the demand transaction load and the constraints for the period of time projected into the future.

In an embodiment, at 250, the demand response scheduler receives revised constraints and generates a revised dispatch demand schedule based on the revised constraints.

In an embodiment, at 260, the demand response scheduler converts the dispatch demand schedule into a worker shift schedule in a format recognized by a scheduling system of the store and provides the worker shift schedule to the scheduling system.

In an embodiment, at 270, the demand response scheduler processes 230 and 240 by mapping the transaction load and the constraints into input recognized by a power demand response system, providing the input to the power demand response system, and obtaining the dispatch demand schedule as output from the power demand response system.

In an embodiment of 270 and at 271, the demand response scheduler converts the dispatch demand schedule into a worker shift schedule in a format recognized by a scheduling system of the store and provides the worker shift schedule to the scheduling system.

In an embodiment, at 280, the demand response scheduler automatically iterates 210-240 at preconfigured intervals of time and generates revised dispatch demand schedules for each interval of time.

In an embodiment, at 290, the demand response scheduler generates multiple versions of the dispatch demand schedule for different levels of time granularity (per hour, per day, etc.) over the period of time.

FIG. 3 is a diagram of another method 300 for demand response resource scheduling, according to an example embodiment. The software module(s) that implements the method 300 is referred to as a “resource schedule manager.” The resource schedule manager is implemented as executable instructions programmed and residing within memory and/or a non-transitory computer-readable (processor-readable) storage medium and executed by one or more processors of a device. The processors that execute the resource schedule manager are specifically configured and programmed for processing the resource schedule manager. The resource schedule manager may have access to one or more network connections during its processing. The network connections can be wired, wireless, or a combination of wired and wireless.

In an embodiment, the device that executes the resource schedule manager is cloud 110. In an embodiment, the device that executes the resource schedule manager is server 110.

In an embodiment, the resource schedule manager is some combination or all of 113, 114, and/or method 200.

The resource schedule manager presents another and, in some ways, an enhanced processing perspective from that which was shown above for system 100 and/or method 200.

At 310, the resource schedule manager derives historical transaction loads over a historical period of time from historical transaction data. Each historical transaction load associated with a given interval of time within the historical period of time (such as each hour within the historical period of time).

In an embodiment, at 311, the resource schedule manager calculates each historical transaction load as an SST average transaction load for SST transactions and a POS terminal average transaction load for POS terminal transactions.

At 320, the resource schedule manager maintains historical attributes obtained from the historical transaction data with each historical transaction load and the corresponding given interval of time. The attributes are similar to actual constraints known for the historical period of time in each interval of time.

In an embodiment of 311 and 320, at 321, the resource schedule manager adds historical weather data to the historical attributes for each historical transaction load.

At 330, the resource schedule manager obtains first constraints for a future period of time from a scheduling system.

In an embodiment of 321 and 330, at 331, the resource schedule manager obtains the first constraints as planned schedules from the scheduling system for events, holidays, and sales.

At 340, the resource schedule manager obtains second constraints associated with workers for the future period of time.

In an embodiment of 331 and 340, at 341, the resource schedule manager obtains the second constraints as forecasted weather data over the future period of time, worker planned time off schedules during the future period of time, worker minimum and maximum shift hours per day and per week, and worker skillset values for operating SSTs and for operating POS terminals.

At 350, the resource schedule manager generates forecasted transaction loads for each given interval of time within the future period of time based on the historical transaction loads and the historical attributes.

At 360, the resource schedule manager generates a dispatch demand schedule for each given interval of time over the future period of time based on the corresponding forecasted transaction loads, the corresponding first constraints, and the corresponding second constraints.

At 370, the resource schedule manager provides the dispatch demand schedule to the scheduling system.

In an embodiment of 341 and 370, at 380, the resource schedule manager processes 350 and 360 by mapping the historical transaction loads, the historical attributes, the first constraints, and the second constraints to input values recognized by a power demand response system and receives the forecasted transaction loads and the dispatch demand schedule as output from the power demand response system.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
calculating a transaction load from historical transaction data for a given store;
obtaining constraints for staff of the store;
forecasting a demand transaction load from the transaction load and the historical transaction data over a given period of time projected into the future; and
generating a dispatch demand schedule for the staff of the store based on the demand transaction load and the constraints for the given period of time.

2. The method of claim 1 further comprising, receiving revised constraints and generating a revised dispatch demand schedule based on the revised constraints.

3. The method of claim 1 further comprising, converting the dispatch demand schedule into a worker shift schedule in a format recognized by a scheduling system of the store and providing the worker shift schedule to the scheduling system.

4. The method of claim 1 further comprising, processing the forecasting and the generated by mapping the transaction load and the constraints to input recognized by a power demand response system, providing the input to the power demand response system, and obtaining the dispatch demand schedule as output from the power demand response system.

5. The method of claim 3 further comprising, converting the dispatch demand schedule into a worker shift schedule in a format recognized by a scheduling system of the store and providing the worker shift schedule to the scheduling system.

6. The method of claim 1 further comprising, automatically iterating the method at preconfigured intervals of time and generating a revised dispatch demand schedule for each interval of time.

7. The method of claim 1 further comprising, generating multiple version of the dispatch demand schedule for different levels of time granularity over the given period of time.

8. The method of claim 1, wherein calculating further includes calculating the transaction load as an average total number of transactions per hour at the store over a historical period of time defined in the historical transaction data.

9. The method of claim 8, wherein calculating further includes calculating a first average total number of transactions per hour at Self-Service Terminals (SSTs) for the store and a second average total number of transaction per hour at Point-Of-Sale (POS) terminals for the store over the historical period of time.

10. The method of claim 9, wherein calculating further includes obtaining historical weather data from a weather service for each date within the historical period of time.

11. The method of claim 10, wherein obtaining further includes obtaining a first portion of the constraints as schedules for events, holidays, and sales associated with the store.

12. The method of claim 1, wherein obtaining further includes obtaining a second portion of the constraints as staff vacation schedules, forecasted weather data over the given period of time, minimum shift hours for each staff member of the staff, maximum shift hours for each staff member, and skillset of each staff member indicating whether each staff member is capable of overseeing a bank of the SSTs, operating the POS terminals, or both overseeing the bank of the SSTs and operating the POS terminals.

13. A method, comprising:
deriving historical transaction loads for transactions over a historical period of time from historical transaction data, each historical transaction load associated with a given interval of time within the historical period of time;
maintaining historical attributes obtained from the historical transaction data with each historical transaction load and the corresponding given interval of time;
obtaining first constraints for a future period of time from a scheduling system;
obtaining second constraints associated with workers for the future period of time;
generating forecasted transaction loads for each given interval of time within the future period of time based on the historical transaction loads and the historical attributes;
generating a dispatch demand schedule for each given interval of time over the future period of time based on the corresponding forecasted transaction load, the corresponding first constraints, and the corresponding second constraints; and
providing the dispatch demand schedule to the scheduling system.

14. The method of claim 13, wherein deriving further includes calculating each historical transaction load as a Self-Service Terminal (SST) average transaction load and a Point-Of-Sale (POS) terminal average transaction load for POS terminal transactions.

15. The method of claim 14, wherein maintaining further includes adding historical weather data to the historical attributes for each historical transaction load.

16. The method of claim 15, wherein obtaining the first constraints further includes obtaining the first constraints as planned schedules from the scheduling system for events, holidays, and sales.

17. The method of claim 16, wherein obtaining the second constraints further includes obtaining the second constraints as forecasted weather data over the future period of time, worker planned time off schedules during the future period of time, worker minimum and maximum shift hours per day and per week, and worker skillset values for operating SSTs and POS terminals.

18. The method of claim 17 further comprising processing the generating the forecasted transaction loads and the generating the dispatch demand schedule by mapping the historical transaction loads, the historical attributes, the first constraints, and the second constraints to input values recognized by a power demand response system and receiving the forecasted transaction loads and dispatch demand schedule as output from the power demand response system.

19. A system, comprising:
at least one server comprising a processor and a non-transitory computer-readable storage medium;
the non-transitory computer-readable storage medium comprising executable instructions; and
the executable instructions when executed by the processor from the non-transitory computer-readable storage medium cause the processor to perform operations comprising:
calculating transaction loads for Self-Service Terminals (SSTs) and Point-Of-Sale (POS) terminals using historical transaction data over a given historical period of time;
maintaining historical attributes associated with each transaction load based on the historical transaction data;
obtaining first constraints for a future period of time from a scheduling system;
obtaining second constraints associated with workers for the future period of time;
mapping the historical transaction loads, the historical attributes, the first constraints, and the second constraints to input data recognized by a power demand response system;
processing the power demand response system with the input data;
receiving as output from the power response system forecasted transaction loads for the SSTs and the POS terminals and a dispatch demand schedule for the workers over the future period of time;
converting the dispatch demand schedule into a worker schedule for the future period of time; and
providing the worker schedule to the scheduling system.

20. The system of claim 19, the executable instructions when executed by the processor from the non-transitory computer-readable storage medium further cause the processor to perform additional operations comprising:
providing a front-end interface to a user-operated device;
receiving revised first constraints and second constraints through the interface; and
iterating to the mapping to produces a revised worker schedule and to provide the revised worker schedule to the scheduling system.
